(19) United States
(12) Patent Application Publication
(10) Pub. No.: US 2019/0292077 A1
(43) Pub. Date: Sep. 26, 2019

(54) WATER CONDITIONER WITH VARIABLE FREQUENCY ELECTROMAGNETIC FIELD

(71) Applicant: WEISMACHER ECO PRIVATE LIMITED, Ahmedabad Gujarat (IN)

(72) Inventors: Rajeshkumar Hariprasad ACHARYA, Ahmedabad Gujarat (IN); Rameshchandra Narayanlal SHARMA, Ahmedabad Gujarat (IN); Yusuf Nazmuddin GHADIALI, Ahmedabad Gujarat (IN)

(73) Assignee: WEISMACHER ECO PRIVATE LIMITED, Ahmedabad Gujarat (IN)

(21) Appl. No.: 16/461,548

(22) PCT Filed: Nov. 17, 2017
(86) PCT No.: PCT/IN2017/050539

§ 371 Date: May 16, 2019

(30) Foreign Application Priority Data
Nov. 19, 2016 (IN) 201621039518

(51) Int. Cl. C02F 1/48

(52) U.S. Cl. CPC C02F 1/485; C02F 2201/483; C02F 2303/22

(57) ABSTRACT

The present invention relates to an apparatus for removal and prevention of 5 scale deposition comprising SMPS (switched mode power supply) (1) for generating DC signal, retrofittable pipe section (3) being fitted in residence water carrying pipe wherefrom the scale is removed or prevented to be deposited, a signal cable (2) being wound around the pipe section (3) to form overlapped coils of optimum turns being connected by center tap (2c), a 10 transistor (4) of low operating frequency electrically connected with signal cable (2) at center tap (2c) formed between overlapped coils. The conductor lead (2a) and conductor lead (2b) are respectively connected to the terminal Band C of the transistor (4). By said configuration, when the signal is applied to the signal cable (2), an alternative electromagnetic field with variable 15 frequency is induced around pipe that effectively removes and prevents the scale forming through the water passed from said conduit.

### FIELD OF THE INVENTION

The present invention relates to a prevention and removal of deposit of scale and more particularly it relates to an apparatus for preventing and removing deposit of scale in conduits or other hollow bodies which contain water by generating alternating magnetic field with variable frequency.

### BACKGROUND OF THE INVENTION

Pipes are generally passages through which liquids such as water or the other kinds are induced and moved. Pipes are typically embedded in floors or walls of buildings. As such pipes are used for a relatively long time, various kinds of foreign substances are susceptible to being stuck on the inner surface and thus scales may be produced. The scales may be solidified as time passes and they are the cause for narrow diameter of a pipe passage. Such scale can pose problems with the plumbing in your home. It can form hard deposits of calcium called scale, affecting faucets, shower-heads, dishwashers, and heating elements of water heaters. This can reduce water flow, heating efficiency, and leave spots on dishes. It can also require more soap to get good suds.

A method has been broadly used to remove scales that water mixed with chemicals passes a pipe and the chemicals contacts with scales to cause chemical reaction. Such system works with an ion-exchange process here the calcium and magnesium in the water is replaced by sodium. As a result, the scales dissolve in water by the chemical reaction. However, it is detrimental to users' health and causes adverse environmental impacts. Further, such devices need constant replenishment of the chemicals and also require considerable installation work. Hence, people generally desire to adapt a scale remover where no chemicals are used for removing scale.

In order to eliminate the aforesaid chemical solution, use of magnetic fields has been suggested to prevent scale formation by using magnetic fields strength to cause molecular changes or solution properties to prevent the bonding of scale-forming particles. For example, permanent magnets have also been used, but were found to cause the formation of soft sludge over the formation of hard scale that tends to cling to the surface. The effect of scale control is greatly limited by such conditions. However, said permanent magnet losses its magnetism over a period of time and thus its efficiency to remove scale is decreased gradually. Hence, said magnets are required to replace over a period of time which is quite cumbersome process. Further, the build up of debris on the magnets can occlude the pipe and thus reduce the flow of water. Such devices also require considerable installation work.

Inline, electro-magnetic systems work like magnetic systems however some of the electro magnetic systems include oscillation of the magnetic field to offset the permanent polarization effect. In such conventional magnetic system, said oscillation of magnetic field is performed by using R-L-C circuit. Here, timer circuit transmit signal to the R-L-C circuit at irregular time interval so that the alternating and variable magnetic field is produced within the coil. Here, said timer transmits the signal of limited current thereby the magnetic field produced in the coil can not be strong enough. Further, strong signal transmitted from the timer causes the heating of timer IC. Thus, the effectiveness of the device is therefore limited.

Hence, it is long standing problem in the art to produce alternating magnetic field of desire strength without causing the problem of overheating the circuit.

### OBJECT OF THE INVENTION

The main object of present invention is to provide a water scale removal and prevention device that resolve problems set forth in prior arts.

Another object of present invention is to provide a water scale removal and prevention device that provides chemical free solution for removing scale.

Further object of present invention is to provide a water scale removal and prevention device that has capability to remove scale from the water carrying apparatus i.e. pipe as well as water storing means i.e. tank.

Further object of present invention is to provide a water scale removal and prevention device that efficiently removes the scale and prevent formation of scale in the water carrying apparatus by producing alternating magnetic field with variable frequency.

Yet another object of present invention is to provide a water scale removal and prevention device that overcome the problems of overheating of circuit and produce strong magnetic field.

### SUMMARY OF THE INVENTION

The present invention relates to an apparatus for removing scale and preventing formation of scale in water supply line. Said apparatus comprises a switched mode power supply for generating DC voltage signal between its positive terminal and negative terminal, at least one signal wire wound around a pipe such that two overlapped coils of optimum number of turns are formed on the pipe, said pipe is configured such that it can retrofit or incorporate into the metallic pipe wherein the formation of scale is removed and prevented, a transistor having characteristic of low operating frequency and at least three terminals. Said signal wire having a two conductor leads that are electrically connected between two selective terminals of the transistor. The center tap formed between said overlapped coils is connected to a positive terminal of the SMPS. Thus, said signal from positive terminal is passed through the coil and the transistor and is received to the negative terminals of the SMPS. When said signal is communicated to the coil, an electromagnetic field is produced surrounding to the coil. Here, said signal is interrupted at irregular time interval by said transistor that causes to produce the alternative electromagnetic field with variable frequency. Said non-continuous electromagnetic field effectively removes and prevent the scale in the water carrying pipes.

### BRIEF DESCRIPTION OF THE DRAWINGS

Objects and advantages of the invention will be apparent from the following detailed description taken in conjunction with the accompanying figures of the drawing wherein:

FIG. 1 shows the block diagram of first embodiment of an apparatus for removal and prevention of scale deposition according to present invention.

FIG. 2 shows the block diagram of second embodiment of an apparatus for removal and prevention of scale deposition according to present invention.

### DETAILED DESCRIPTION OF THE INVENTION

Before explaining the present invention in detail, it is to be understood that the invention is not limited in its application to the details of the construction and arrangement of parts illustrated in the accompany drawings. The invention is capable of other embodiments, as depicted in different figures as described above and of being practiced or carried out in a variety of ways. It is to be understood that the phraseology and terminology employed herein is for the purpose of description and not of limitation.

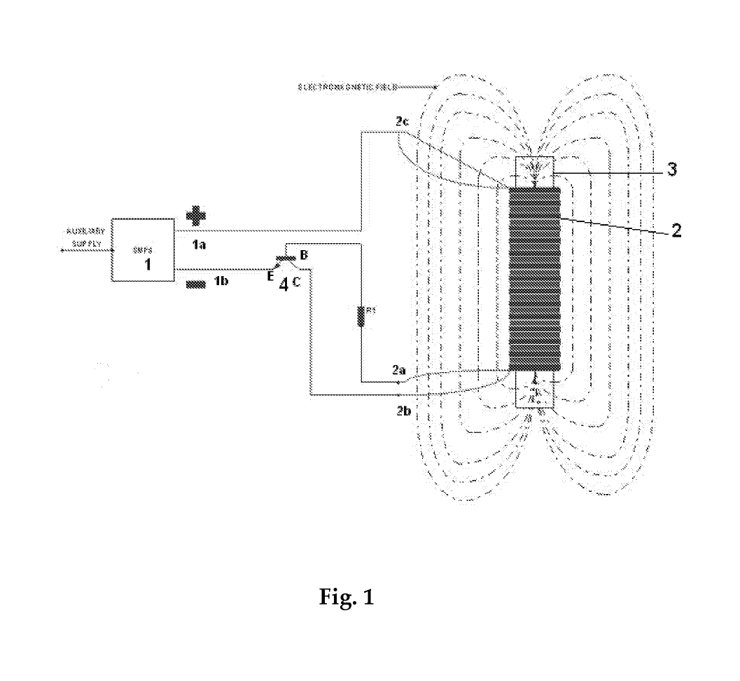

Referring to FIG. 1, an apparatus for preventing scaling and/or removing scale in a housing (not shown) is shown. Although not shown in the drawings, the housing in this embodiment is a metallic or a non-metallic pipe configured to carry water. The apparatus of the present invention, however, may be applied to other containers including conduits or tanks used to carry water such as hard water that can cause scaling.

Referring to FIG. 1, there is provided a diagram of a first embodiment of apparatus for scale remover and preventer which comprise a SMPS (switched mode power supply) (1) having a positive terminal (1a) and a negative terminal (1b) and generates DC voltage signal between said terminals (1a, 1b) from the auxiliary power supply, a pipe section (3), particularly made from copper or plastic, a signal cable (2) having a first conductor lead (2a) and a second conductor lead (2b) and is shown coiled around the outer surface of the pipe section (3) and a NPN transistor (4), preferably TTC5200, having terminals (B, C, E). Conductor lead (2a, 2b) of said signal cable (2) are respectively connected to the terminals (B, C) of the transistor (4) and remaining terminal (E) is connected to a negative terminal (1b) of the SMPS (1) as shown in FIG. 1. The pipe section (3) is configured such that it is retrofittable or incorporable into the housing pipe. Once installed, opposing ends of the pipe section (3) adjoin to the respective openings of the housing pipe such that the plastic pipe section (3) and the housing pipe are in fluidly communication with one another.

It is to be noted that said pipe section (3) is preferably made from the copper or plastic material. Further, the purpose of using the TTC5200 NPN transistor is having its characteristics of low operating frequency which is suitable for varying the frequency of the magnetic field generated in the coil. However, it is within the scope of present invention to utilize the other transistor having the similar configuration of TTC5200. Further, it is within the scope of present invention to adapt battery for producing DC voltage signal for replacing the SMPS.

Referring continuous to FIG. 1, there is shown a configuration of winding said signal cable (2) on the pipe (3). Said signal cable (2) is wound such that when about half of the length of the signal cable (2) is coiled on the pipe (3) to form a first coil by winding optimum number of turns, a center tap (2c) is formed by extending and banding some portion of the signal cable (2). Another half portion of the signal cable is coiled on the pipe (3) in a reverse linear direction to form a second coil. Thus, two overlapped coils are formed on the pipe (3) that contains about similar number of turns.

Now, referring FIG. 1 again, said center tap (2c) is electrically connected to the positive terminal (1a) of the SMPS (1). In said embodiment, the first conductor lead (2a) of signal cable (2) is connected to the terminal B via resistor R1 for limiting the base current flow and the second conductor lead (2b) of signal cable (2) is connected to the terminal C of the transistor (4). Said terminal E of the transistor (4) is connected to the negative terminal (1b) of the SMPS (1). Here, said DC signal applied to the signal cable (2) produces the electromagnetic field (shown in dotted line) by completed the circuitry from the positive terminal (1a) to the negative terminal (1b). The aforesaid configuration enables the transistor (4) to come in the path of said DC signal during flowing from the positive terminal (1a) to the negative terminal (1b).

In operation, the standard AC power supply is given to the input of the SMPS (1) that produces the stable DC voltage signal between said positive terminal (1a) and negative terminal (1b). Now, when said signal is applied to the center tap (2c) of signal cable (2), said coils are energized to produce alternating magnetic field wherein lines of flux of magnetic field produced from one coil is directed along the fluid flow path established by said pipe (3) and the lines of flux of magnetic field produced from another (second) coil is directed to the opposite direction of fluid flow path. Thus, alternating magnetic field is produced in the coils. From centre tap (2c), said current is divided by flowing through the conductor leads (2a, 2b). Here, said current is applied to the terminal B from the first conductor lead (2a) by passing through the resistor R1 that controls the current of said signal. Similarly, said signal is applied to the terminal C by second conductor lead (2b) without using any current limiting component in its path. Due to characteristics of low operating frequency of transistor (4), said signal will alternatively pass from the terminal B to terminal E and terminal C to terminal E. Here in both case, magnetic field of different value is produced in the both coils which is shown below.

In first embodiment, the magnetic field is calculated in the overlapped coils on the pipe by passing the signal of 0.26 amp in both coils. Each said coil contains N=100 turns wound on the L=0.06 m length of pipe section (3). The magnetic field produced in both coils is calculated below.

In first coil, said signal is passed through the resistor of R1=6.6K whereby the current is reduced up to 0.8*10⁻³ amp. Thus according to equation,

$$\begin{matrix}B 1 = 4 Π * {10}^{- 7} * 100 * 0.8 * {10}^{- 3} / 0.06` \\ = 1.67 μ T\end{matrix}$$

magnetic field is produced.

In second coil, according to equation,

$$\begin{matrix}B 2 = 4 Π * {10}^{- 7} * 100 * 0.26 / 0.06` \\ = 0.544 mT magnetic field is produced .\end{matrix}$$

By comparing magnetic field induced in the both coils, it is seen that alternating magnetic field at variable frequency is generated in the coils at different time interval by using said transistor. The frequency of magnetic field is varied in the range of 360 Hz to 3.70 kHz. Here, both said magnetic field B1 and B2 will be in opposite direction. Further, said transistor is equipped with heat sink that keep cool said transistor. Moreover, by increasing the current, the value of magnetic field in each coil is increased without causing any problem of overheating. Thus, desired strength of electro-magnetic field is achieved in the coils. Further, the heat of entire circuit is also dissipated by the cooling fan (not shown) that is operated by said DC signal or any other external power supply means.

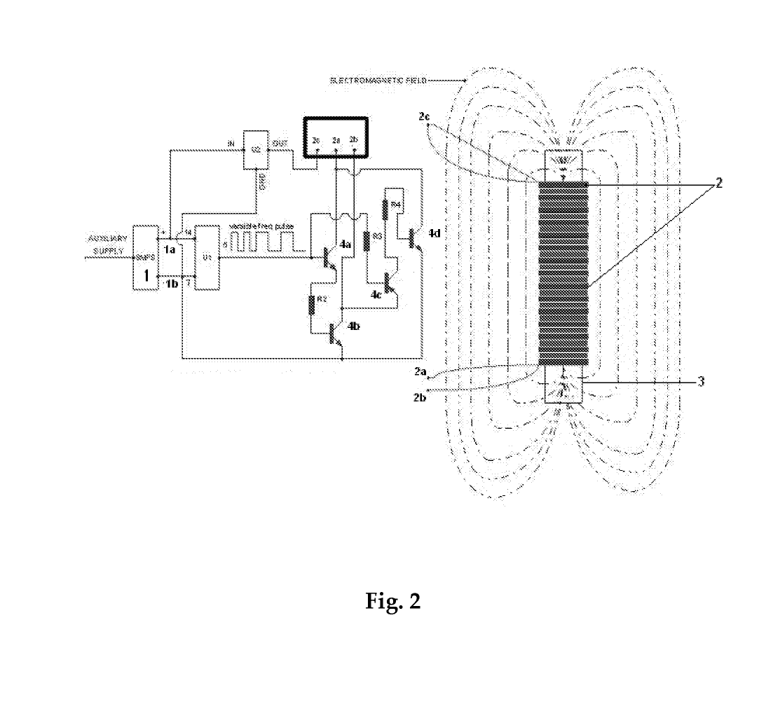

In another embodiment shown in FIG. 2, for enhancing ranges of variable frequency of the electro-magnetic field, plurality of transistors (4a, 4b, 4c, 4d) are utilized. For sake of understanding, the center tap (2c) and conductor leads (2a, 2b) are shown in the different box. In this embodiment, the transistor 4a, 4b and 4d, are BC337, 2N3904 and 2N2222, respectively are NPN transistor and 4c, is BC327, and is PNP transistor. As shown in FIG. 2, the DC signal from the SMPS is supplied to the center tap (2c) by passing through the regulator means (U1). After that, said signal is passed from said coils towards its conductor lead (2a) and conductor lead (2b). Here, the configuration of said transistor (4a, 4b, 4c and 4d) varies the frequency of electro-magnetic field in the manner discussed below.

As shown in FIG. 2, a timer (U2) receives signal from the SMPS and applied the signal by logic 0 and 1. Logic “0” present “low” signal and logic “1” present “high signal”. When, the timer (U2) sends the logic 1, the transistor (4a) will be activated so that the signal from the terminal (2a) is applied to the base terminal of the transistor (4b) by passing through the resistor R2. Thus, transistor (4b) will be activated that allows the signal to pass from conductor lead (2b) to negative terminal (1b) of the SMPS. Likewise, when the timer (U2) sends logic 0, the transistor (4c) (PNP transistor) will be actuated so that signal from the conductor lead (2b) is applied to the base terminal of the transistor (4d). Thus, the transistor (4d) will be activated that enable the signal to pass from the conductor lead (2a) to negative terminal (1b) of the SMPS. Further, said timer chips (U2) sends pulse of logic “0” and logic “1” at irregular time interval. By said configuration, the frequency of electromagnetic field produced in the coil is varied in broad range that is more effective for removing scale from the pipes. Here, the frequency of magnetic field induced in the coils is varied in the range of 10 Hz to 400 Hz. Further, in second embodiment, modulated magnetic field is generated. Thus, every time, the frequency and magnitude of electromagnetic field will be varied. Further, in present invention, said timer (U2) is utilized to provide base current to the transistors which is much lower (i.e. in micro ampere) compared to current drawn from timer in R-L-C circuit. Hence, unlike R-L-C circuit, the timer doesn't get hot according to present invention.

According to present invention, by variation in frequency of alternating electro-magnetic field, a multiple decrease in the amount of calcium in the deposit is achieved. Thus, formation of scale in the pipe is removed. Thus, the installation of the instant invention on the main water supply line of a residence may prevent the formation of scale within the piping system of the home.

The invention has been explained in relation to specific embodiment. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

We claim:

1. An apparatus for removal and prevention of scale deposition comprises:
a generator (1) having a first (positive) terminal (1a) and second terminal (negative terminal) (1b) for generating a DC signal between said terminals (1a, 1b);
a retrofittable elongated tubular member (3) configured to be interconnected with the water carrying conduit in an axial manner, having at a first end an inlet and at a second end longitudinally opposite the first end an outlet for the flowing fluid;
at least one signal wire (2) being wrapped around said elongated member to form a first coil and a second coil; said wire having a conductor lead (2a, 2b) at its both end;
at least one transistor (4) having three terminals (B, C, E) associated with the generator (1) for ensuring that the signal is non continuous and a frequency modulated with variable frequency;
wherein said coils are overlapped and are electrically connected to each other to form a center tap (2c);
wherein said center tap (2c) is electrically connected with the first terminal (1a) of the generator (1) so that the signal is applied to the coils to energize the coils and generate a corresponding variable electromagnetic field in the conduit;
wherein one of said conductor lead (2a) of the wire (2) is electrically connected to the terminal B of the transistor (4);
wherein one of said conductor lead (2b) of the wire (2) is electrically connected to the terminal C of the transistor (4);
wherein negative terminal (1b) of the generator (1) is electrically connected to the terminal E of the transistor (4);
wherein said signal energize the first coil and second coil to produce alternating magnetic field in the coils.

2. The apparatus for removal and prevention of scale deposition as claimed in claim 1, wherein the successive turns of each of the first and second coil are in opposite direction.

3. The apparatus for removal and prevention of the scale deposition as claimed in claim 1, wherein said transistor (4) having a characteristic of low operating frequency whereby it vary the frequency of said magnetic field induced in the first and second coil.

4. The method for removal and prevention of scale deposition comprises following steps:
a) winding a number of turns of signal wire (2) to form a first coil and winding a number of turns on the first coil with same wire in opposite direction to form a second overlapped coil;
b) forming a center tap (2c) at the connecting point of the said coils;
c) electrically connecting said center tap (2c) with the first (positive) terminal (1a) of the generator (1);
d) electrically connecting one of the conductor lead (2a) of the signal wire (2) to the terminal B of the transistor (4);
e) electrically connecting one of the conductor lead (2b) of the signal wire to the terminal C of the transistor (4);
f) electrically connecting the negative terminal (1b) of the generator (1) to the terminal E of the transistor (4);
g) applying said signal through said electrical connection so as to pass through said first coil and second coil;
h) producing alternating magnetic field in said coils by applying signal to said overlapped coils;
i) varying the frequency of the magnetic field produced in said coils by said transistor (4) by interrupting said signal for effectively removing the scale.
